(19) United States
(12) Patent Application Publication
(10) Pub. No.: US 2015/0199234 A1
(43) Pub. Date: Jul. 16, 2015

(54) MEMORY DEVICE, MEMORY SYSTEM, AND METHOD OF OPERATING MEMORY DEVICE

(71) Applicant: SAMSUNG ELECTRONICS CO., LTD., SUWON-SI (KR)

(72) Inventors: HYOJIN CHOI, SUWON-SI (KR); SU-A KIM, SEONGNAM-SI (KR); HAK-SOO YU, SEONGNAM-SI (KR); SEONG-YOUNG SEO, HWASEONG-SI (KR); MU-JIN SEO, SEOUL (KR)

(21) Appl. No.: 14/595,856

(22) Filed: Jan. 13, 2015

(30) Foreign Application Priority Data
Jan. 13, 2014 (KR) 10-2014-0004062

(51) Int. Cl. G06F 11/10

(52) U.S. Cl. CPC G06F 11/1076

(57) ABSTRACT

A method of operating a memory device includes: checking for errors in data read from a first address of a memory cell array of the memory device; counting the number of errors that occurred in the data read from the first address; receiving a first command for data read from the first address; determining whether the number of errors that occurred in the data read from the first address is greater than or equal to a first value; and mapping the first address to a second address, if the number of errors that occurred in the data read from the first address is greater than or equal to the first value.

### CROSS-REFERENCE TO RELATED APPLICATIONS

This application claims priority under 35 U.S.C. §119 from Korean Patent Application No. 10-2014-0004062, filed on Jan. 13, 2014, in the Korean Intellectual Property Office, and all the benefits accruing therefrom, the contents of which are herein incorporated by reference in their entirety.

### BACKGROUND

Embodiments of the inventive concept are directed to a memory device, a memory system, and a method of operating the memory device, and more particularly, to a memory device that lowers an error generation probability, a memory system, and a method of operating the memory device.

The processing capacity and a processing speed demanded in an electronic device have increased. Therefore, the operation of a memory device included in an electronic device has increased in speed, and the amount of data processed in a memory device has increases. As a result, a probability that an error will occur in the operation of a memory device has increased. Many electronic devices, such as memory devices, include on-chip error check and correction (ECC). However, the error correction capability of the on-chip ECC is restricted by the chip area, power consumption, operation latency, etc. Thus, the probability that an error will occur in an electronic device may exceed the error correction capability of the on-chip ECC.

### SUMMARY

Embodiments of the inventive concept may provide a memory device that can reduce an error generation probability, a memory system, and a method of operating the memory device.

Embodiments of the inventive concept may also provide a memory device that can reduce an error generation probability and reduces power consumption, a memory system, and a method of operating the memory device.

Embodiments of the inventive concept may also provide a memory device that can reduce an error generation probability and reduce a layout area, a memory system, and a method of operating the memory device.

According to an embodiment of the inventive concept, there is provided a method of operating a memory device comprising an on-chip error check and correction (ECC). The method may include: checking for errors in data read from a first address of a memory cell array of the memory device; counting the number of errors that occurred in the data read from the first address; receiving a first command for data read from the first address; determining whether the number of errors that occurred in the data read from the first address is greater than or equal to a first value; and if the number of errors that occurred in the data read from the first address is greater than or equal to the first value, mapping the first address to a second address.

Checking for errors in the data read from the first address may be performed in response to a read command or a refresh command.

The first command may be a refresh command.

The first address may refer to a normal cell array of the memory cell array, and the second address may refer to a redundancy cell array of the memory cell array.

The first address may be a row address of the memory cell array.

If the number of bit errors of each error correction unit of the data read from the first address is less than or equal to a maximum number of bits that are corrected by the on-chip ECC, the number of errors that occurred in the data read from first address may be stored in a first table.

The method may further include: if the number of errors occurring in data read from the first address is greater than or equal to the first value, storing mapping information of the first and second addresses in a second table.

The method may further include: receiving a second command for data of the first address; and executing the second command with respect to data at the second address with reference to the second table.

The method may further include: checking for errors in an error correction unit of the data read from a whole region of the first address; and if the number of errors that occurred in the data read from the whole region of the first address is less than or equal to a second value, deleting information about the first address from the second table.

The method may further include: if an error occurs in an arbitrary error correction unit of the data read from the first address, storing the number of errors that occurred in the data read from the first address, in a third table.

The method may include storing the number of errors in a first table. Determining whether the number of errors that occurred in data read from the first address is greater than or equal to the first value may include: if the first command is received, referring to the first table; and if the first address exists in the first table, referring to a first flag of the first table to determine whether the number of errors that occurred in data read from the first address is greater than or equal to the first value.

The memory device may be a dynamic random access memory (DRAM).

According to another embodiment of the inventive concept, there is provided a method of operating a memory device comprising an on-chip error check and correction (ECC). The method may include: when performing a read or refresh operation with respect to a first address, reading data from the first address of a memory cell array of the memory device and checking whether a correctable error occurs in the read data; counting the number of errors that occurred in the data read from the first address and, if the number of errors is greater than a predetermined value, determining that the first address is an address in which there is a high probability that an uncorrectable error will occur; writing data stored at the first address to a second address; and if an access to the first address is requested, changing the access to the first address into an access to the second address.

According to another embodiment of the inventive concept, there is provided a method of operating a memory device comprising an on-chip error check and correction (ECC), including receiving an active command for data at a first row address, determining whether the first row address exists in a second table, wherein a wordline of a second row address mapped to the first address is activated, if the first row address exists in the second table, and a wordline of the first row address is activated, if the first row address does not exist in the second table, receiving a column address of a read command; and performing error check and correction on data at the column address.

The method may further include increasing a number of errors that may occur in data at the first row address, if the error check and correction detected a correctable error and the first row address exists in a first table, storing the first row address in the first table, if the error check and correction detected a correctable error and the first row address does not exist in a first table, wherein if an empty entry for storing the first row address does not exist in the first table, a least recently entry is deleted from the first table and outputting data read from the column address.

The method may further include receiving a refresh command for data at the first row address; if the first row address exists in the second table and a second flag is set to zero, activating a wordline of the first row address; detecting and correcting errors in data read from the activated first row address, wherein if a correctable error occurred in data read from the activated first row address, a number of errors that occurred in data read from the activated first row address is increased; and determining whether the number of errors that occurred in data read from the activated first row address is less than or equal to a second value, wherein if the number of errors is less than or equal to the second value, a second flag is set to one and a wordline of a second row address is inactivated, and if the number of errors is greater than the second value, the wordline of the second row address is activated.

If the first row address does not exist in the second table, the method may include performing the refresh operation on data of the first row address, if the first row address does not exist in a first table, or the first flag of a first row address is not set to one.

If the first row address does not exist in a second table, the method may include searching for a second row address to replace the first row address, if the first row address exists in the first table and the first flag of a first row address is set to one. If the second row address is found, the method may include mapping information of the first row address and the second row address is stored in a second table, moving data stored at the first row address to the second row address, and deleting an entry of the first row address from the first row table. If the second row address is not found, the method may include performing the refresh operation on data of the first row address.

### BRIEF DESCRIPTION OF THE DRAWINGS

FIG. 1 is a flowchart of a method of operating a memory device according to an embodiment of the inventive concept.

FIG. 2 is a block diagram of a memory device according to an embodiment of the inventive concept.

FIG. 3 illustrates a first table of an error information storage unit of FIG. 2, according to an embodiment of the inventive concept.

FIG. 4 is a flowchart of an operation of determining whether the number of errors that occur in a first address of FIG. 1 is greater than or equal to a first value, according to an embodiment of the inventive concept.

FIG. 5 illustrates a second table of the error information storage unit of FIG. 2, according to an embodiment of the inventive concept.

FIG. 6 is a flowchart of a process of forming first and second tables in a method of operating a memory device, according to an embodiment of the inventive concept.

FIG. 7 is a flowchart of a method of operating a memory device, according to another embodiment of the inventive concept.

FIG. 8 illustrates a third table of the error information storage unit of FIG. 2, according to an embodiment of the inventive concept.

FIG. 9 is a flowchart of a method of operating a memory device, according to another embodiment of the inventive concept.

FIGS. 10 through 12 are flowcharts that illustrate detailed operations performed in a dynamic random access memory (DRAM) that includes on-chip error check and correction (ECC), according to an embodiment of the inventive concept.

FIG. 13 is a flowchart of a refresh operation of a memory device that is performed with reference to the third table of FIG. 12.

FIG. 14 is a flowchart of a refresh operation of a memory device that is performed with reference to the first table of FIG. 12.

FIGS. 15 through 17 are block diagrams of memory systems according to embodiments of the inventive concept.

FIG. 18 is a perspective view that illustrates a memory device implemented by stacking a plurality of semiconductor layers, according to another embodiment of the inventive concept.

FIG. 19 is a block diagram of a mobile device according to an embodiment of the inventive concept.

FIG. 20 is a block diagram of a memory system according to another embodiment of the inventive concept.

FIG. 21 is a block diagram of a memory module according to an embodiment of the inventive concept.

FIGS. 22 and 23 are block diagrams of memory systems according to embodiments of the inventive concept.

FIG. 24 is a block diagram of a computing system that includes a memory system, according to an embodiment of the inventive concept.

### DETAILED DESCRIPTION OF THE EMBODIMENTS

The attached drawings for illustrating embodiments of the inventive concept are referred to in order to gain a sufficient understanding of the inventive concept, the merits thereof, and the objectives accomplished by embodiments of the inventive concept. Hereinafter, exemplary embodiments of the inventive concept will be described in detail by explaining embodiments of the inventive concept with reference to the attached drawings. Like reference numerals in the drawings may denote like elements.

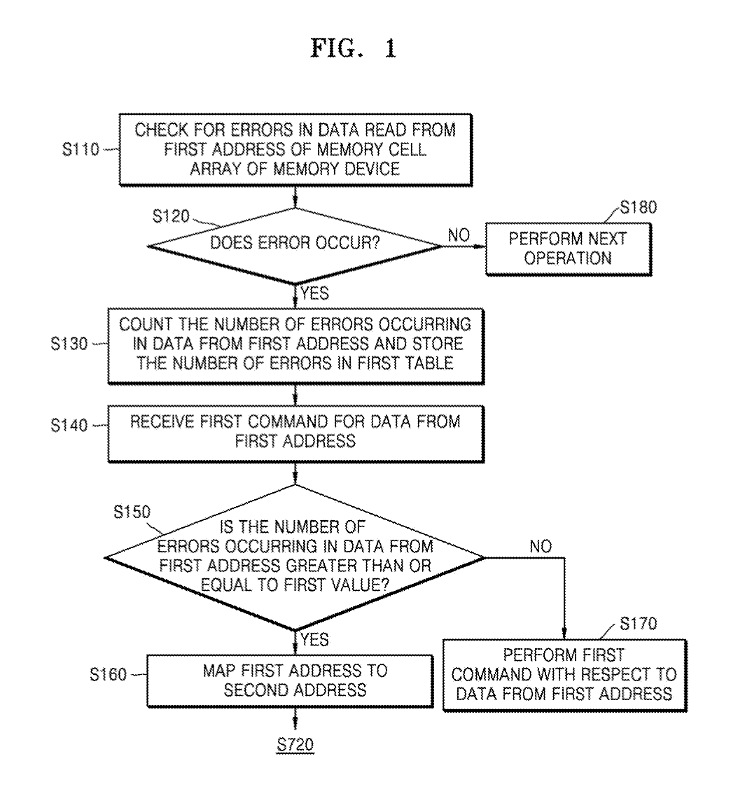

FIG. 1 is a flowchart of a method of operating a memory device according to an embodiment of the inventive concept. A method of a present embodiment may be an operating method performed in a dynamic random access memory (DRAM) that includes on-chip error check and correction (ECC). Referring to FIG. 1, in operation S110, data read from a first address of a memory cell array of the memory device is checked for errors. If, in operation S120, it is determined that an error has occurred, the number of errors occurring in the data read from the first address is counted and stored in a first table in operation S130. In operation S140, a first command for the data from the first address is received. If the number of errors occurring in the data from the first address is greater than or equal to a first value in operation S150, the first address is mapped to a second address in operation S160.

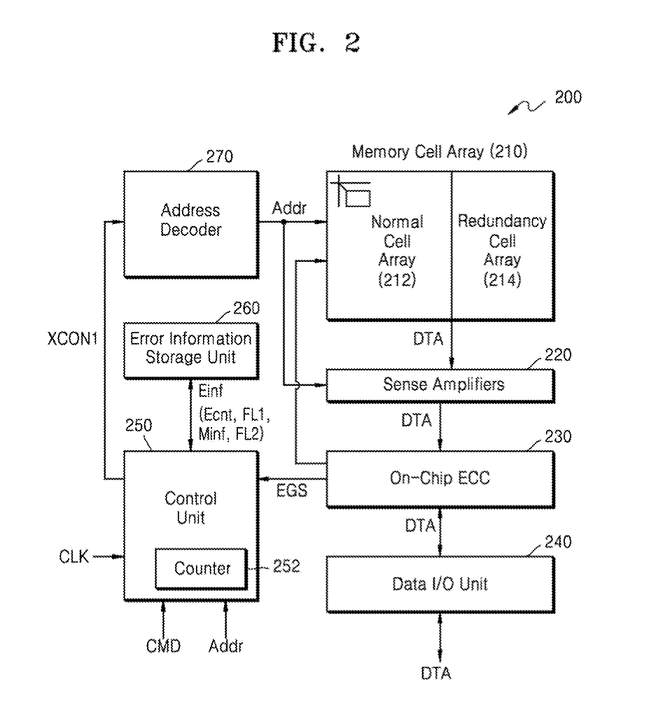

FIG. 2 is a block diagram of a memory device 200 according to an embodiment of the inventive concept. Referring to FIG. 2, the memory device 200 includes a memory cell array 210, sense amplifiers 220, an on-chip ECC 230, a data input/output (I/O) unit 240, a control unit 250, an error information storage unit 260, and an address decoder 270.

The memory cell array 210 includes a plurality of memory cells (MCs) that are organized into rows and columns. The MCs may respectively store data DTA or bit values included in the data DTA. The memory cell array 210 includes a normal cell array 212 and a redundancy cell array 214. The normal cell array 212 is a memory cell array that is addressed by a normal addressing method of the memory device 200. In a process of manufacturing the memory device 200, a series of test processes are performed. An arbitrary memory cell of the normal cell array 212 may be determined to be a defective cell by the series of processes. In this case, an address that refers to a row or a column corresponding to the defective cell of the normal cell array 212 may be replaced with an address that refers to a redundancy row or column. The redundancy cell array 214 may include a plurality of memory cells organized in rows and columns that are replaced as described above.

The redundancy cell array 214 of the memory device 200 according to a present embodiment may statically replace cells of the normal cell array 212 that are determined to be defective through a test of the manufacturing process. A cell that is determined to be defective after the memory device 200 is installed in a memory system may also be replaced. This will be described in more detail below.

The sense amplifiers 220 sense a voltage of a column of the memory cell array 210 corresponding to an address Addr included in a command CMD requested to be executed in the memory device 200, such as a read command or a refresh command, to identify data DTA stored in the address Addr. The identified data DTA may be output from the memory device 200 through the data I/O unit 240 in response to the read command. Alternatively, the identified data DTA may be rewritten in one or more MCs corresponding to the same address Addr or another address Addr of the memory device 200 in response to the refresh command.

The on-chip ECC 230 encodes the data DTA to generate parity data when writing the data DTA in the memory cell array 210. The parity data may be stored in a parity data storage area of the normal cell array 212. When reading the data DTA from the memory cell array 210, the on-chip ECC 230 decodes the parity data of the read data DTA to check for and correct errors in the data DTA. The data DTA may be read from the memory cell array 210 in response to a read command or a refresh command. The on-chip ECC 230 may check for errors and, if an error occurs, transmit an error generation signal (EGS) to the control unit 250. The on-chip ECC 230 may include an encoder and a decoder that perform the above-described operations.

As a process of a memory device is refined, the memory device 200 according to a present embodiment includes an ECC engine as an on-chip ECC to improve yield and reduce chip defects. The on-chip ECC 230 may perform ECC operations on sectors of the data DTA identified by the sense amplifiers 220, referred to herein below as error correction units.

In this case, the on-chip ECC 230 may restrict the number of bits used for checking for or correcting errors in the error correction unit. For example, an error correction capability of the on-chip ECC 230 may be restricted by restrictions on the area of a chip on which the memory device 200 is implemented, an operating time and power consumption needed by the ECC, etc. For example, there exist restrictions on the increase in area of a storage space for storing a parity bit encoded by the on-chip ECC 230, an increase in the decoding latency caused by the on-chip ECC 230, etc. in which the area of a storage space increases in proportion to error correction ability.

An optimum performance of the on-chip ECC 230 according to a present embodiment under the above-described restrictions may obtained by a 1-bit error correction . The memory device 200 according to a present embodiment may to generate errors at a rate that is less than or equal to the error correction ability of the on-chip ECC 230. For example, the on-chip ECC 230 of the memory device 200 may have a 1-bit error correction ability with respect to the error correction unit and operate to lower a probability that an error of 2 or more bits will occur. This will be described in more detail below.

The control unit 250 may receive a command CMD to perform an operation in the memory device 200. For example, if the received command CMD is a write command, the control unit 250 may write the data DTA corresponding to the write command into one or more MCs corresponding to an address Addr included in the write command. If the received command CMD is a read command, the control unit 250 may read the data DTA stored in one or more MCs corresponding to an address Addr included in the read command. Alternatively, if the memory device 200 is a DRAM, and the received command CMD is a refresh command, the control unit 250 may read and rewrite the data DTA stored in one or more MCs corresponding to an address Addr included in the refresh command. To perform these commands, the control unit 250 may transmit a first control signal XCON1 to an address decoder 270 that activates rows and columns corresponding to the address Addr included in the command CMD.

However, embodiments of the inventive concept are not limited thereto. For example, the control unit 250 may internally generate a command in the memory device 200 in response to the received command CMD or based on a cycle of an internal operation clock CLK. For example, if the memory device 200 is a DRAM, the control unit 250 may generate an internal command of the memory device 200, such as a self-refresh command, etc. In addition, the control unit 250 may control an ECC operation of the on-chip ECC 230 and implement the method of FIG. 1.

The error information storage unit 260 may store various types of error information Einf that are generated by the method of FIG. 1. The error information storage unit 260 may be implemented as a register, etc. The error information storage unit 260 may receive the error information Einf from the control unit 250 and store the error information Einf. As will be described below, the error information Einf may include information about the number of errors Ecnt, a first flag FL1, a second flag FL2, etc.

The address decoder 270 activates rows (wordlines) and columns (bitlines) of the memory cell array 210 corresponding to the external address Addr received from an external source or the internal address Addr stored in the error information storage unit 260 in response to the first control signal XCON1 received from the control unit 250.

The method of FIG. 1 will now be described based on an operation of the memory device 200 of FIG. 2. However, this embodiment is exemplary and non-limiting, and the method of FIG. 1 may be applied to a memory device having a different structure.

Referring to FIGS. 1 and 2, operation S110 of checking for errors in the data DTA read from the first address of the memory cell array 210 of the memory device 200 may be performed by the on-chip ECC 230. The first address may be a row unit of the memory cell array 210, i.e., a row address. Operation S110 may be performed with respect to data DTA that is read in response to a read command or a refresh command. For example, if the first address is a row address, the read command or the refresh command may be a command to read or refresh column data of the first address.

The read command may be a command CMD that is processed by the control unit 250 and received from an external source. However, the refresh command may be a command CMD that is processed by the control unit 250 and received from an external source or may be internally generated in response to a command CMD received from an external source or based on a cycle of the internal operation clock CLK.

The error generation signal EGS generated by the on-chip ECC 230 may be transmitted to the control unit 250. For example, if an error is determined to have occurred in the data DTA read from the first address in operation S120, the on-chip ECC 230 may transmit the EGS, which indicates an error occurrence, and an address in which the error occurs, to the control unit 250.

The control unit 250 may receive the EGS to count the number of errors occurring in the data from the first address, i.e., the number of errors Ecnt. For this, the control unit 250 may include a counter 252. If the number of error bits included in each error correction unit of data DTA read from the first address is less than or equal to the maximum number of error bits that can be corrected by the on-chip ECC 230, the number of errors Enct may be counted in operation S130. For example, if the error correction ability of the on-chip ECC 230 is 1 bit in the error correction unit, the error correction unit has y bits, the first address refers to rows of y×128 bits, a size of the data DTA read from the first address is y×8 bits, and a 1-bit error occurs in one of the eight parts defined by dividing the read data DTA by y bits, the number of errors Ecnt occurring in the first address may be counted.

If the number of error bits included in each error correction unit of the data DTA read from the first address is greater than or equal to the maximum number of error that can be corrected by the on-chip ECC 230, the control unit 250 may process a “fail” command of the data DTA or transmit the data DTA to the external source. For example, an external control logic or a memory controller may consider data for which errors are not corrected by the on-chip ECC 230 as failing, or perform an ECC operation using another error correction scheme.

As described above, the first address may be a row unit of the memory cell array 210, i.e., a row address. However, the first address is not limited thereto. The control unit 250 may count the number of errors Ecnt occurring in address units of blocks, columns, or sections of the first address. In operation S130, the control unit 250 stores the counting result, i.e., the number of errors Ecnt that have occurred in the first address, in the error information storage unit 260.

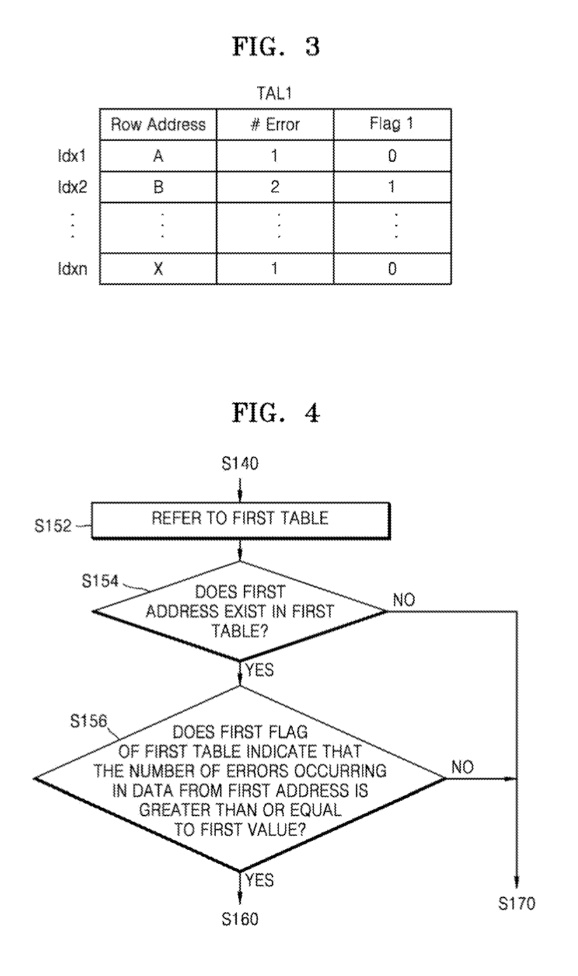

FIG. 3 illustrates a first table TAL1 of the error information storage unit 260 of FIG. 2, according to an embodiment of the inventive concept. Referring to FIGS. 1 through 3, the first table TAL1 may store the number of errors Ecnt that have occurred in data from the first address. Each index Idx1 through Idxn of the first table TAL1 includes a row address, the number of errors Ecnt occurring in data from each row address, and a first flag FL1. For example, the first index Idx1 includes the number of errors Ecnt occurring in data from row address A as 1 and the first flag FL1 as 0. For example, the second index Idx2 includes the number of errors Enct occurring in data from row address B as 2 and the first flag FL1 as 1. However, if the first address is an address other than a row address, the first table TAL1 may include the number of errors Ecnt that occur in data from another address and the first flag FL1 of the another address.

Referring to FIGS. 1 and 2 again, the control unit 250 receives a first command CMD for the data from the first address in operation S140. The first command CMD may be a refresh command. In operation S150, the control unit 250 may determine whether the number of errors Ecnt that have occurred in the data read from the first address is greater than or equal to a first value, with reference to the first table TAL1 of FIG. 3, in response to the first command CMD.

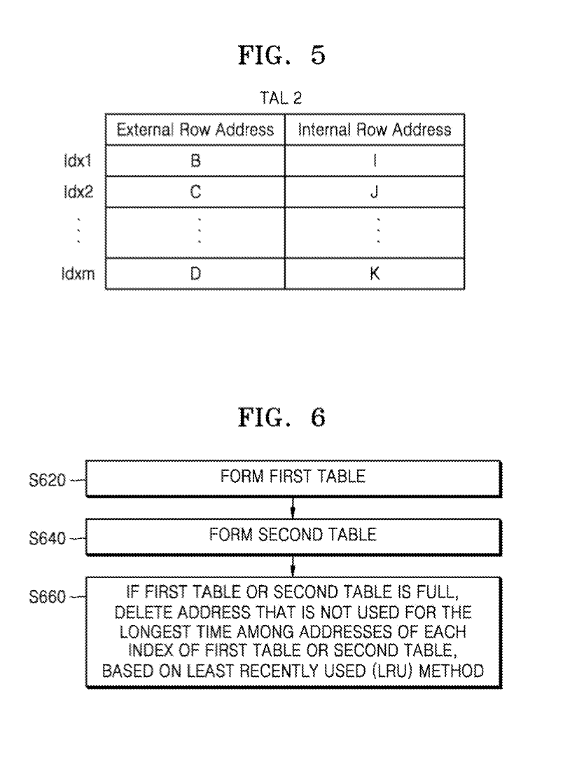

FIG. 4 is a flowchart of operation S150 of FIG. 1, which determines whether the number of errors occurring in data from the first address is greater than or equal to a first value, according to an embodiment of the inventive concept. Referring to FIGS. 2 through 4, operation S150 includes: operation S152 of referring to the first table TAL1 if the first command CMD for data of the first address is received; operation S154 of determining whether the first address exists in the first table TAL1; and operation S156 of determining whether the number of errors Ecnt occurring in the data from the first address is greater than or equal to the first value, with reference to the first flag FL1 of the first table TAL1.

For example, in operation S140, the control unit 250 may receive a first command CMD for data of the first address, such as a refresh command, from an external source. The control unit 250 may refer to the first table TAL1 in response to the first command CMD in operation S152 to determine whether the first address exists in the first table TAL1 in operation S154. For example, if the first address is row address B, the control unit 250 may determine that row address B exists in the first table TAL1 of FIG. 3. If row address B exists in the second index Idx2 of the first table TAL1 in operation S154, the control unit 250 can determine, in operation S156, whether the number of errors Ecnt that occurred in data from row address B is greater than or equal to the first value, based on the first flag FL1 of the second index Idx2.

For example, in the memory device 200 according to a present embodiment, the on-chip ECC 230 may have a 1-bit error correction capability in the error correction unit. In this case, the first value may be set to a value that corresponds to the error correction capability of the on-chip ECC 230, a reliability of the memory device 200, etc. For example, if the number of errors Ecnt occurring in data from a row address is greater than or equal to 2, i.e., the first value is 2, the first flag FL1 may have a value of 1. If the number of errors Ecnt that occurred in data from each first address is less than or equal to 2, the first flag FL1 TAL1 may have a value of 0. If the number of errors Ecnt that occurred in data from the first address is greater than or equal to 2 when referring to the first table TAL1 in response to a first command, the control unit 250 may set the first flag FL1 to 1.

If, in operation S154, it is determined that the first address does not exist in the first table TAL1 or in operation S156, it is determined that the first flag FL1 of the first address is 0, the control unit 250 executes, in operation S170, the first command CMD with respect to data from the first address. For example, if the first command CMD is a refresh command, the control unit 250 may read the data DTA from the first address, refresh the data DTA, and rewrite the data DTA to the first address.

If, in operation S156, the first flag FL1 for the first address is 1, the control unit 250 may execute the first command CMD at operation S170, with respect to a second address which replaced, in operation S160, the first address. For example, if the first command CMD is the refresh command, the control unit 250 may read the data DTA from the first address, refresh the data DTA, and write to the second address.

For example, a first address of the normal cell array 212 may be replaced with a second address of the redundancy cell array 214. For example, the first address may be an external address that is provided from an external source or the memory controller, and the second address may be an internal address that is generated inside the memory device 200. The control unit 250 may store mapping information Minf for the first and second addresses in the error information storage unit 260.

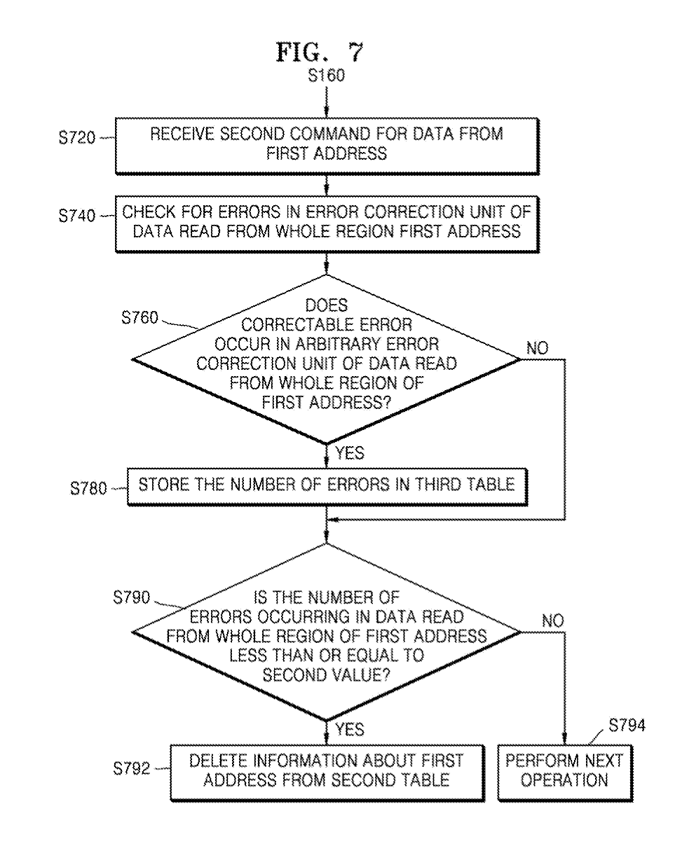

FIG. 5 illustrates a second table TAL2 of the error information storage unit 260 of FIG. 2, according to an embodiment of the inventive concept. Referring to FIGS. 2 and 5, the second table TAL2 may include the mapping information Minf of the first and second addresses and store the mapping information Minf in the error information storage unit 260. Each of indices Idx1 through Idxm of the second table TAL2 may include an external row address and an internal row address that is mapped onto the external row address. For example, the first index Idx1 of the second table TAL2 includes a mapping relation between external row address B that is a first address and internal row address I that is a second address. The first address stored in the second table TAL2 may be deleted from the second table TAL2. For example, the external row address B may be deleted from other indices Idxm of the second table TAL2.

Referring to FIGS. 1 and 2 again, as described above, if, in operation S150, it is determined that the number of errors Ecnt that occurred in data from an arbitrary first address is greater than or equal to a first value, the control unit 250 may execute the first command CMD with respect to data from the second address. For this, the control unit 250 may refer to the second table TAL2 of FIG. 5. For example, if a refresh command is executed with respect to data for an address of which first flag FL1 in the first table TAL1 is 1, the control unit 250 may transmit a first control signal XCON1 corresponding to the second address to the address decoder 270 with reference to the second table TAL2.

If, in operation S150, it is determined that the number of errors Ecnt that occurred in data from the first address is less than or equal to the first value, the control unit 250 may execute in operation S170 the first command CMD with respect to data from the first address. For example, if the refresh command is executed with respect to an address for which first flag FL1 in the first table TAL1 is 0, the control unit 250 may transmit a first control signal XCON1 corresponding to the first address to the address decoder 270.

If, in operation S120, no error is detected in data from the first address, the control unit 250 performs a next operation in operation S180. For example, if operation S110 is performed for a read command, a refresh command, etc., a next command subsequent to the read command or the refresh command may be processed.

According to the memory device 200 and a method of operating the memory device 200 according to a present embodiment as described above, the on-chip ECC 230 may be included to improve efficiency of an error correction. In addition, if a probability that an error will occur in an arbitrary unit, such as a row unit, increases, a corresponding address may be statically replaced with an address of the redundancy cell array 214 to perform reliable ECC operations under the restricted error correction capability of the on-chip ECC 230. For example, in the memory device 200 that includes an on-chip ECC 230 having a 1-bit error correction ability with respect to an error correction unit, based on restrictions on chip area, operation latency, power consumption, etc., the number of correctable errors is counted in an arbitrary unit, such as a row unit. If the number of errors that occur in each row is greater than or equal to a preset value, a corresponding row may be replaced with another row to lower a probability that an uncorrectable error of 2 or more bits will occur in an error correction unit.

In other words, although correctable error may be detected by the on-chip ECC 230, if the number of errors is greater than or equal to a predetermined value, the control unit 250 may determine that a probability that an uncorrectable error will occur in a corresponding area is high. As a result, an access to the corresponding area is restricted to lower the probability that the uncorrectable error is detected by the on-chip ECC 230. Therefore, reliability of the memory device 200 or a system including the memory device 200 may be improved. Here, an address that is replaced to minimize an increase in the chip area may be an address of the redundancy cell array 214.

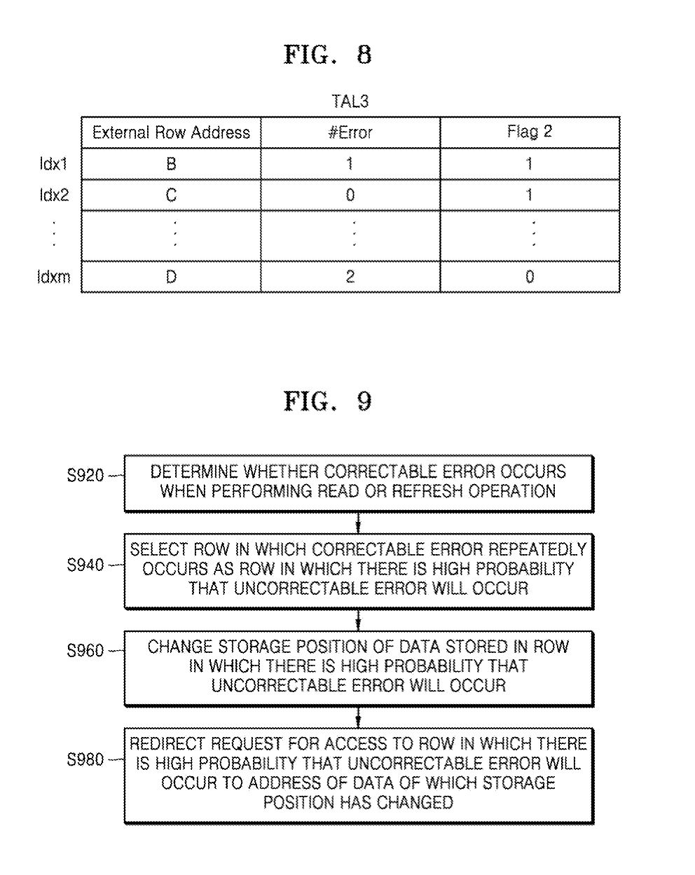

FIG. 6 is a flowchart of a process of forming first and second tables in a method of operating a memory device, according to an embodiment of the inventive concept. Referring to FIGS. 2 and 6, the method of operating the memory device 200 may include: operation S620 of forming a first table; operation S640 of forming a second table; and operation 660 of deleting an address that is not used for the longest time from the addresses included for each index of the first table or the second table, based on a least recently used (LRU) method, if the first table or the second table is full. Operations S620 and S640 are the same as described above with respect to FIGS. 3 and 5, and their detailed descriptions are omitted. The control unit 250 may count the number of accesses to addresses of indices of each table to perform operation S660.

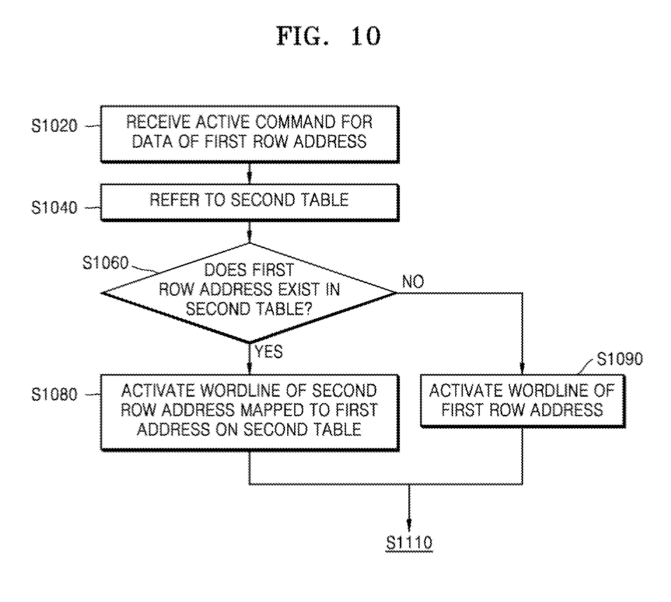

FIG. 7 is a flowchart of a method of operating the memory device 200, according to another embodiment of the inventive concept. Referring to FIGS. 2 and 7, a method may include operations S720, S740, S760, S780, S790, and S792. After the first command is performed with respect to data of the second address in operation S160, i.e., after the mapping information Minf of the first and second addresses are stored in the second table TAL2 of FIG. 5, a second command for data of the first address is received in operation S720. In operation S740, data read from the whole region of the first address is checked for an error in an error correction unit. In operation S760, the control unit 250 determines whether a correctable error has occurred in an arbitrary error correction unit of the data read from the whole region of the first address. If a correctable error has occurred, the number of errors Ecnt is stored in a third table, in operation S780. In either case, in operation S790, the control unit 250 determines whether the number of errors Ecnt that occurred in the data read from the whole region of the first address is less than or equal to a second value. If the number of errors Ecnt is less than or equal to a second value, then, in operation S792, information about the first address is deleted from the second table TAL2.

The second command may be a refresh command, and the first address may be a row address. The refresh command may be executed for a row unit. If the on-chip ECC 230 includes one decoder, the error in the error correction unit in the data read from the whole region of the first address is checked by dividing a size of data at the first address, for example, the number of bits in a row, by a size of the error correction unit. In this case, after a refresh operation is performed, the number of errors occurring in the data read from the whole region of the first address may be counted. However, if a number of decoders included on the on-chip ECC 230 equals the number acquired by dividing the number of bits in the row by the size of the error correction unit, a one-time decode operation may be performed with respect to the first address to count the number of errors that occurred in the data read from the whole region of the first address in operation S740.

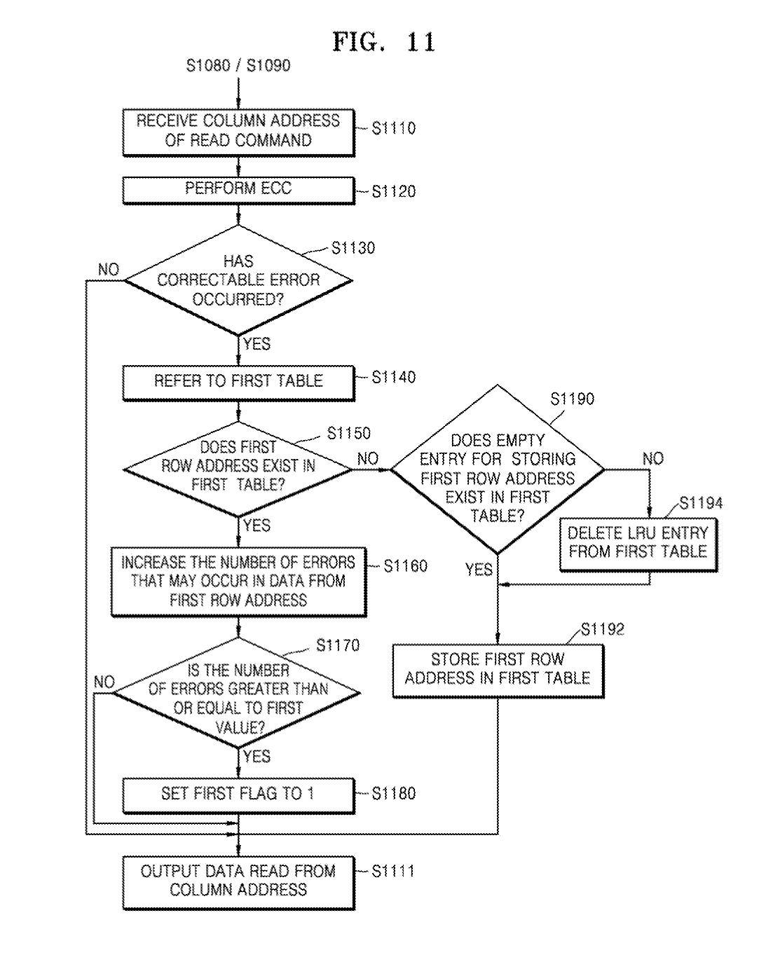

The third table may be formed as shown in FIG. 8. FIG. 8 illustrates a third table TAL 3 of the error information storage unit of FIG. 2, according to an embodiment of the inventive concept. Referring to FIG. 8, the third table TAL3 may store the number of errors occurring in the second address Ecnt.

Each of indices Idx1 through Idxm of the third table TAL3 includes a first address, such as an external row address, the number of errors Ecnt occurring in data at the first address, and a second flag FL2. For example, the first index Idx1 may store the number of errors Ecnt that occurred in data at external row address B, where external row address B is stored in the first index Idx1 of the second table TAL2 of FIG. 2, and a second flag FL2 of the external row address B. The number of errors Ecnt that occurred in data at the external row address B may be determined by dividing data read from the whole region of the external row address B into error correction units of the on-chip ECC 230 and determining whether an error has occurred in each of the error correction units.

For example, if an error occurs in one of the error correction units into which the data read from the whole region of the external row address B is divided, and errors do not occur in the other error correction units, the number of errors Ecnt that have occurred in the data of external row address B is 1. For example, if errors occur in two of the error correction units into which the data read from the whole region of the external row address B is divided, and errors do not occur in the other error correction units, the number of errors Ecnt occurring in the data of external row address B is 2.

If the number Ecnt of errors is less than or equal to a second value, the second flag FL2 may be set to 1. For example, if the on-chip ECC 230 has a 1-bit error correction capability, the second value may be set to 1. Therefore, if the number of errors Ecnt that occurred in the data of external row address B is 1, the second flag FL2 of the external row address B may be set to 1.

Referring to FIGS. 2 and 7, if the second flag FL2 of the first address in the third table TAL3 of FIG. 8 is 1, information about the first address is deleted from the second table TAL2 in operation S792. If, in operation S790, it is determined that the number of errors that occurred in the data read from the whole region of the second address is greater than or equal to the second value, a next operation may be performed in operation S794. Although a mapping relation is set in the second table TAL2 as described above, and no uncorrectable error occurs in data of the first address, an access to data at the first address may be re-permitted. As described above, if an uncorrectable error occurs, the uncorrectable error may be processed as “fail”.

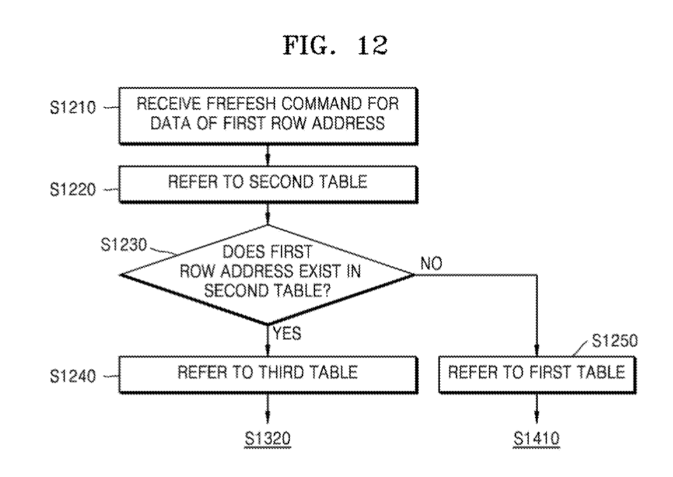

FIG. 9 is a flowchart of a method of operating the memory device 200, according to another embodiment of the inventive concept. Referring to FIG. 9, in operation S920, the control unit 250 determines whether a correctable error occurs in a read or refresh operation. In operation S940, the control unit 250 selects a row in which the correctable error repeatedly occurs as a row in which there is a high probability that an uncorrectable error will occur. In operation S960, the control unit 250 changes a storage position of data that is stored in the row in which there is the high probability that the uncorrectable error will occur. In operation S980, the control unit 250 redirects a request for an access to the row in which there is the high probability that the uncorrectable error will occur, to an address of the data of which storage position was changed.

Operation S920 may correspond to operation S110. Operation S940 may correspond to operation S130.

Operations S960 and S980 may correspond to operation S160.

In operation S940, the memory device 200 that includes the on-chip ECC 230 of FIG. 2 with a 1-bit error correction ability with respect to the error correction unit may have a 70% or more probability that an uncorrectable error will occur in a row in which a correctable error occurs repeatedly two or more times. In operation S960, a storage position of data stored in the normal cell array 212 of FIG. 2 may be changed to another position inside the memory device 200, for example, in the redundancy cell array 214 of FIG. 2.

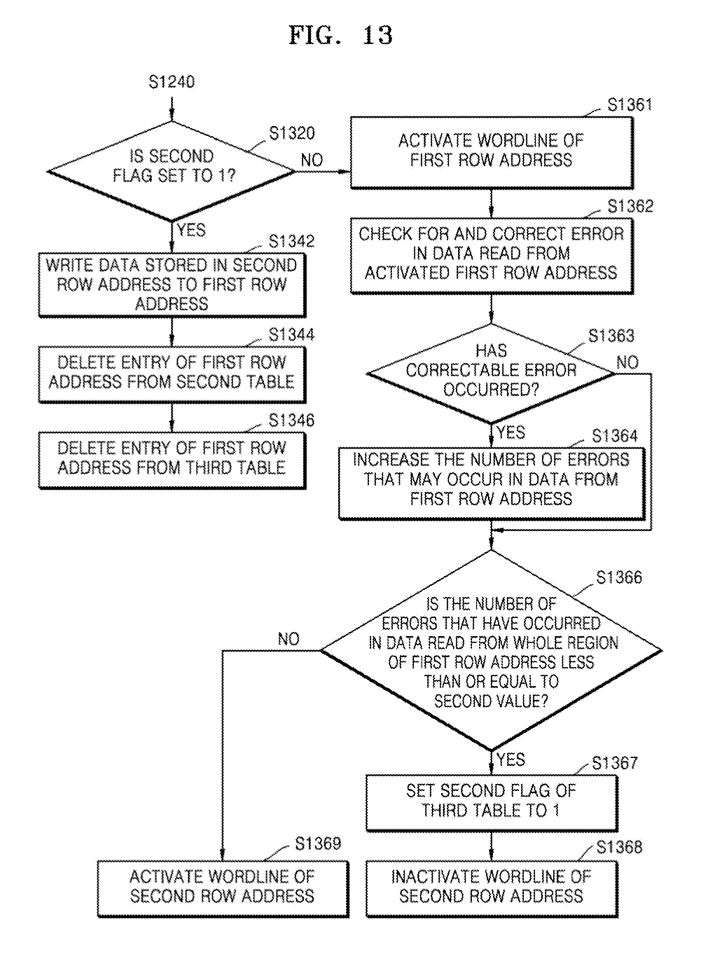

FIGS. 10 through 12 are flowcharts of detailed operations performed in a DRAM that includes an on-chip ECC, according to an embodiment of the inventive concept. Referring to FIGS. 2 and 10, the control unit 250 receives in operation S1020 an active command for data of a first row address. In operation S1040, the control unit 250 refers to the second table TAL2 of FIG. 5. In operation S1060, the control unit 250 determines whether the first row address exists in the second table TAL2. If the first row address exists in the second table TAL2, the control unit 250 controls the address decoder 270 to activate, in operation S1080, a wordline of a second row address mapped to the first row address in the second table TAL2. If the first row address does not exist in the second table TAL2, the control unit 250 controls the address decoder 270 to activate, in operation S1090, a wordline of the first row address.

Referring to FIGS. 2 and 11, if the first row address or the second row address is activated in operations S1080 and S1090 of FIG. 10, the control unit 250 receives a column address for data of a read command in operation S1110. In operation S1120, the control unit 250 receives a result of an ECC performed by the on-chip ECC 230 on the data at the column address and row address. If, in operation S1130, the on-chip ECC 230 detected that a correctable error has occurred, the control unit 250 refers to the first table TAL1 of FIG. 3 in operation S1140. If, in operation S1150, it is determined that a first row address exists in the first table TAL1, then, in operation S1160, the number of errors Ecnt that may occur in data from the first row address is increased. If, in operation S1170, it is determined that the number of errors Ecnt in the first table TAL1 is greater than or equal to a first value, then, in operation S1180, the control unit 250 sets a first flag FL1 to 1.

If, in operation S1150, it was determined that the first row address does not exist in the first table TAL1, then, in operation S1190, the control unit 250 determines whether an empty entry for storing the first row address exists in the first Table TA1. If an empty entry exists in the first table TAL1, the control unit 250 stores the first row address in the first table TAL1 in operation S1192. If an empty entry does not exist in the first table TAL1, the control unit 250 deletes an LRU entry from the first table TAL1 in operation S1194 and then stores the first row address in the deleted entry in operation S1192. If, in operation S1170, it was determined that the number of errors Ecnt in the first table TAL1 is less than a first value, or after setting the first flagFL1 to 1, or, in operation S1130, the on-chip ECC 230 did not detect the occurrence of a correctable error, the control unit 250 outputs data read from a corresponding column address in operation S1111.

Referring to FIGS. 2 and 12, in operation S1210, the control unit 250 receives a refresh command for data of a first row address. In operation S1220, the control unit 250 refers to the second table TAL2 of FIG. 5. If, in operation S1230, it is determined that the first row address exists in the second table TAL2, then, in operation S1240, the control unit 250 refers to the third table TAL3 of FIG. 3. If, in operation S1240, the first row address does not exist in the second table TAL2, then, in operation S1250, the control unit 250 refers to the firs table TAL1 of FIG. 3.

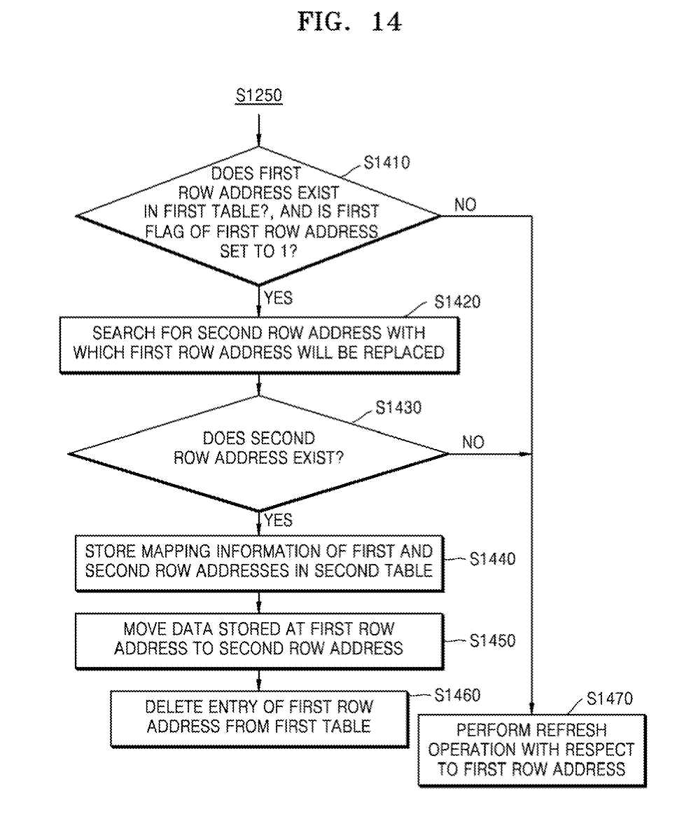

FIG. 13 is a flowchart of a refresh operation performed in a memory device when referring to the third table TAL3, according to an embodiment of the inventive concept. Referring to FIGS. 2 and 13, the control unit 250 referred to the third table TAL3 in operation S1240 determines in operation S1320 whether the second flag FL2 is set to 1. If the second flag FL2 is set to 1, then, in operation S1342, the control unit 250 writes data stored at a second row address to a first row address to perform a refresh operation. In operation S1344, the control unit 250 deletes an entry of the first row address from the second table TAL2 of FIG. 2. In operation S1346, the control unit 250 deletes the entry of the first row address from the third table TAL3.

If, at operation S1320, the second flag FL2 is not set to 1, then, address in operation S1361, the control unit 250 controls the address decoder 270 to activate a wordline of the first row. The control unit 250 receives in operation S1362 an ECC result of the on-chip ECC 230 performed on an error correction unit in data read from the activated first row address. If, in operation S1363, it is determined that a correctable error has occured, then, in operation S1364, the number of errors Ecnt that have occurred in the first row address is increased.

If, in operation S1366, it is determined that the number of errors Ecnt that have occurred in the data read from the whole region of the first row address is less than or equal to a second value, then, in operation S1367, the control unit 250 sets a second flag FL2 of the third table TAL3 to 1 and inactivates a wordline of the first row address in operation S1368.

If, in operation S1363, it was determined that a correctable error) has not occurred in the data read from the first row address, the control unit 250 determines, in operation S1366, whether the number of errors Ecnt that have occurred in the data read from the whole region of the first row address is less than or equal to a second value, without increasing the number of errors Ecnt. If, in operation S1366, it is determined that the number of errors Ecnt that have occurred in the data read from the whole region of the second row address is greater than the second value, then, in operation S1369, the control unit 250 activates the wordline of the second address to perform a refresh operation with respect to the second address.

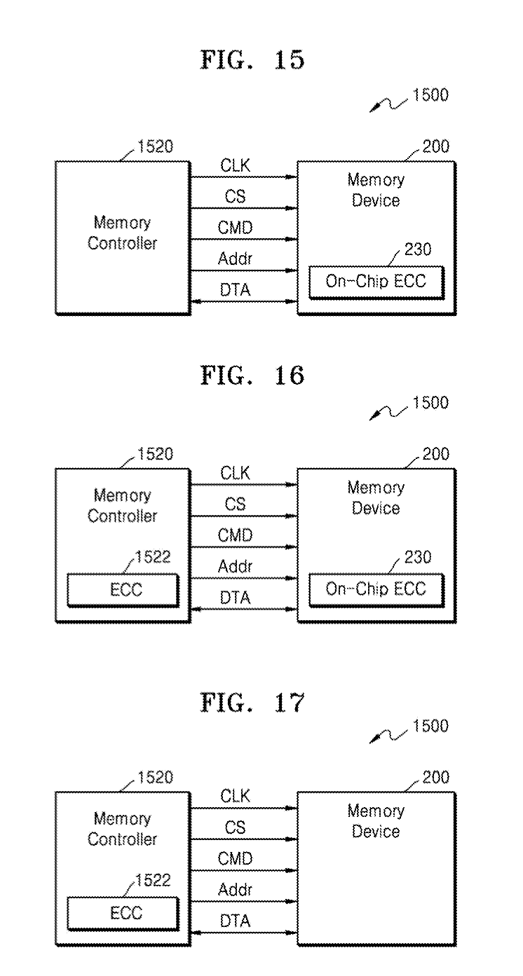

FIG. 14 is a flowchart of a refresh operation performed in a memory device when referring to the first table TAL1 of FIG. 12, according to an embodiment of the inventive concept. Referring to FIGS. 2 and 14, if, in operation S1410, it is determined that a first row address exists in the first table TAL1 and a first flag FL1 of the first row address in the first table TAL1 is set to 1, then, in operation S1420, the control unit 250 searches for a second row address to replace the first row address. If, in operation S1430, it is determined that the second row address to replace the first row address exists, then, in operation S1440, the control unit 250 stores mapping information Minf of the first and second row addresses in the second table TAL2. In operation S1450, the control unit 250 moves data stored at the first row address to the second row address. In operation S1460, the control unit 250 deletes an entry of the first row address from the first table TAL1.

If, in operation S1410, it was determined that the first row address does not exist in the first table TAL1 or that a first flag FL1 of the first row address is not set to 1, or, in operation S1430, it was determined that the second address with which the first row address will be replaced does not exist, then, in operation S1470, the control unit 250 performs a refresh operation with respect to the first row address.

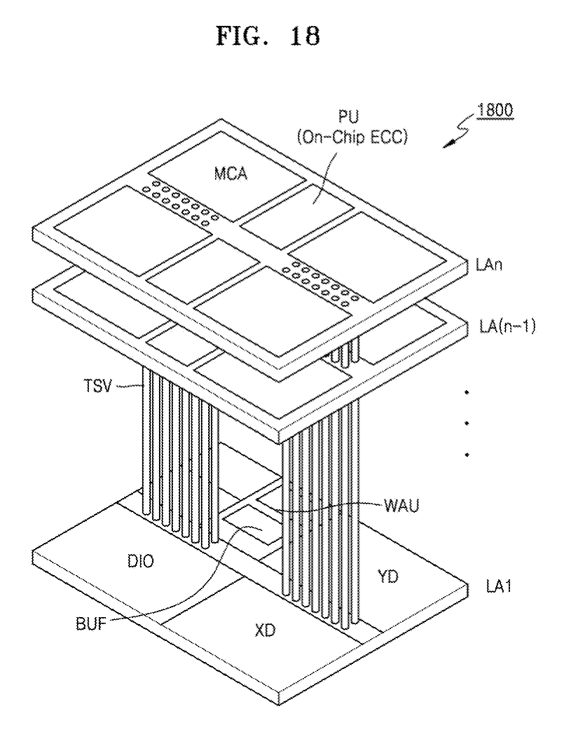

FIG. 15 is a block diagram of a memory system 1500 according to an embodiment of the inventive concept. Referring to FIG. 15, the memory system 1500 includes a memory controller 1520 and a memory device 200. The memory controller 1520 provides various types of signals to the memory device 200 to control an operation of the memory device 200. For example, the memory controller 1520 provides a clock signal CLK, a chip selection signal CS, a command CMD, an address Addr, etc. to the memory device 200. In addition, data DTA for write and read operations is transmitted and received between the memory controller 1520 and the memory device 200. The memory device 200 may include the on-chip ECC 230 and may have the same structure as the memory device 200 of FIG. 2 and operate according to the method of FIG. 1.

In FIG. 15, the on-chip ECC 230 is included in the memory device 200, and the memory controller 1520 does not include an ECC. However, embodiments of the inventive concept are not limited thereto. Referring to FIG. 16, which illustrates the memory system 1500 according to another embodiment, the memory controller 1520 may also include an ECC engine 1522. In this case, the ECC engine 1522 of the memory controller 1520 and the on-chip ECC 230 of the memory device 200 may have different error correction abilities. For example, the error correction capability of the ECC engine 1522 of the memory controller 1520 may be greater than the error correction capability of the on-chip ECC 230 of the memory device 200. In this case, the ECC engine 1522 of the memory controller 1520 may perform ECC operations on data that is not corrected by the on-chip ECC 230 of the memory device 200.

Referring to FIG. 17, which illustrates the memory system 1500 according to another embodiment, the memory device 200 may lack the on-chip ECC 230, and the memory controller 1520 may include the ECC engine 1522. Here, the method of FIG. 1 may be applied to error processing performed by the ECC engine 1522 of the memory controller 1520. For example, an address of a region in which a probability that an error will occur is greater than an error correction capability of the ECC engine 1522 of the memory controller 1520 may be replaced with an address from the redundancy cell array 214 of FIG. 2. In FIG. 17, pins may be added to the memory controller 1520 or the memory device 200, or undefined pins may be allocated as pins of an internal address, i.e. a second address, of a redundancy cell array of the memory device 200, so that the memory controller 1520 provides the internal address to the memory device 200. Alternatively, the timing for providing an external address of a normal cell array may be time-divided to provide the internal address.

If it is determined that a there is a high probability of an uncorrectable error occurring in the memory system 1500 of FIGS. 15 through 17, an access to a corresponding area may be restricted to lower the probability that the uncorrectable error will occur, through an on-chip ECC. Therefore, reliability of the memory system 1500 may be improved. Also, as described above, an address that replaces an address in which there is a high probability that an uncorrectable error will occur, is an address of the redundancy cell array. Therefore, an increase in a whole area of the memory system 1500 may be minimized.

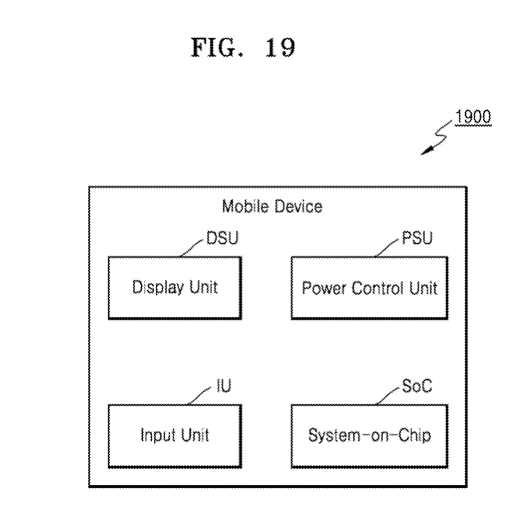

FIG. 18 is a perspective view that illustrates a memory device 1800 implemented by stacking a plurality of semiconductor layers, according to another embodiment of the inventive concept. As shown in FIG. 18, the memory device 1800 may include a plurality of semiconductor layers LA1 through LAn. Each of the semiconductor layers LA1 through LAn may be a DRAM chip that includes DRAM cells, or some of the semiconductor layers LA1 through LAn may be master chips that interface with an external memory controller, and the others may be slave chips that store data.

In FIG. 18, the semiconductor layer LA1 that is positioned in the lowest level is a master chip, and the other semiconductor chips LA2 through LAn are slave chips.

The plurality of semiconductor layers LA1 through LAn transmit and receive signals with each other through through silicon vias (TSVs), and the master chip LA1 communicates with the external memory controller through a conductor formed on an outer surface. A structure and an operation of the memory device 1800 will now be described based on the first semiconductor layer LAI being a master chip and the n^{th} semiconductor layer LAn being a slave chip. The first semiconductor layer LA1 includes various types of circuits for driving memory cell arrays (MCAs) included in the slave chips. For example, the first semiconductor layer LAI may include a row driver XD for driving a wordline of a MCA, a column driver YD for driving a bitline, a data input/output (DIO) unit for controlling data input and output, a write command determiner (WAU), and an address buffer BUF for receiving and buffering an address from an external source.

Each semiconductor layer, for example, the n^{th} semiconductor layer LAn, may include an MCA and other peripheral circuits that drive the MCA, such as a row and/or column selector that selects a row and a column of an MCA, and a peripheral circuit area PU in which a bitline sense amplifier, etc. are disposed. For example, a transition control unit may be disposed in the peripheral circuit area PU. The on-chip ECC 230 of FIG. 2 may be disposed in the peripheral circuit area PU. Data, such as write data or modulation data, that is to be written in the semiconductor layers LA2 through LAn may be provided from the first semiconductor layer LA1 through the TSV.

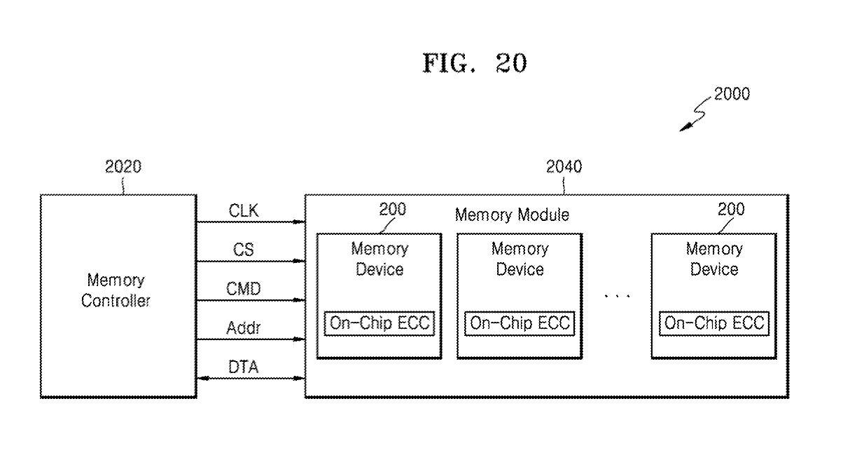

FIG. 19 is a block diagram of a mobile device 1900 according to an embodiment of the inventive concept. Referring to FIG. 19, the mobile device 1900 may include a display unit (DSU) that interfaces with a user, an input unit (IU), such as a keypad, a touch screen, etc., that receives a user input, a power control unit (PSU) that provides power to the mobile device 1900, and a system on-chip (SoC). The mobile device 1900 may be implemented as one of various types of devices such as a portable phone, a smartphone, an MP3 sound system, a notebook personal computer (PC), a tablet PC, etc. In addition, the mobile device 1900 may include other devices according to the functions of the mobile device 1900. The SoC may include a memory device and/or a memory system according to an embodiment of the inventive concept that may reduce an error occurrence probability, thereby improving reliability of the memory device.

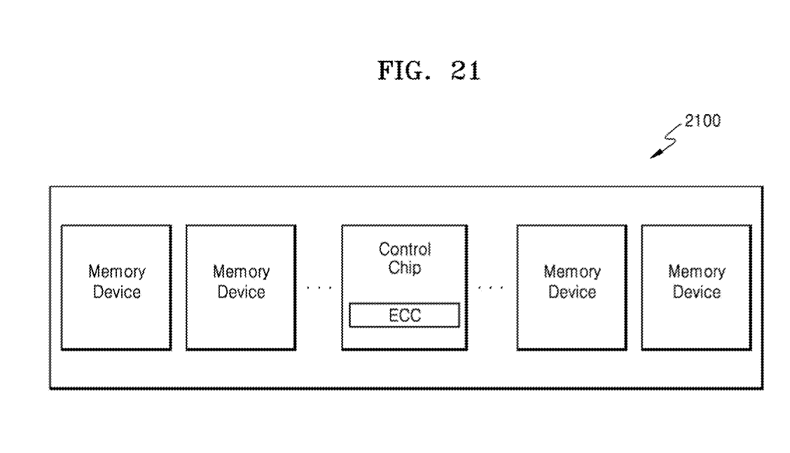

FIG. 20 is a block diagram of a memory system 2000 according to another embodiment of the inventive concept. Referring to FIG. 20, the memory system 2000 includes a memory module 2040 and a memory controller 2020. The memory module 2040 includes one or more memory devices 200 that are installed on a module board, and the memory devices 200 may be DRAM chips. In addition, the memory devices 200 may have a same structure as the memory device 200 of FIG. 2 and operate according to a method of FIG. 1. The memory controller 2020 may outputs various signals for controlling the memory devices 200 that are installed in the memory module 2040. For example, the memory controller 2020 may transmit various types of signals such as those shown in FIG. 15 to the memory module 2040.

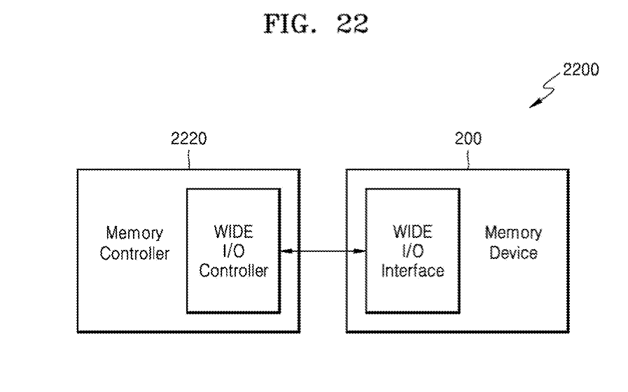

FIG. 21 is a block diagram of a memory module 2100 according to an embodiment of the inventive concept. Referring to FIG. 21, the memory module 2100 may include memory chips and a control chip. The memory chips may store data. The control chip may control the memory chips in response to various types of signals received from a memory controller. For example, the control chip may activate a memory chip corresponding to a chip selection signal received from an external source. The control chip of the memory module 2100 according to a present embodiment may include an ECC. The control chip may perform an ECC operation with respect to data respectively read from the memory chips. Here, the control chip of the memory module 2100 may replace an address in which a preset number of errors occur with another address, such as that of a redundancy cell array of each memory chip, to lower an error occurrence probability when an error occurrence probability is greater than an error correction capability of the ECC, thereby improving reliability. In the embodiment of FIG. 21, pins may be added to the memory chips and the memory device 200, or undefined pins may be allocated as pins of an internal address, i.e. a second address, of the redundancy cell array of the memory device 200, so that the memory chips provide the internal address to the memory device 200. Alternatively, the timing for providing an external address or a first address of a normal cell array may be time-divided to provide the internal address.

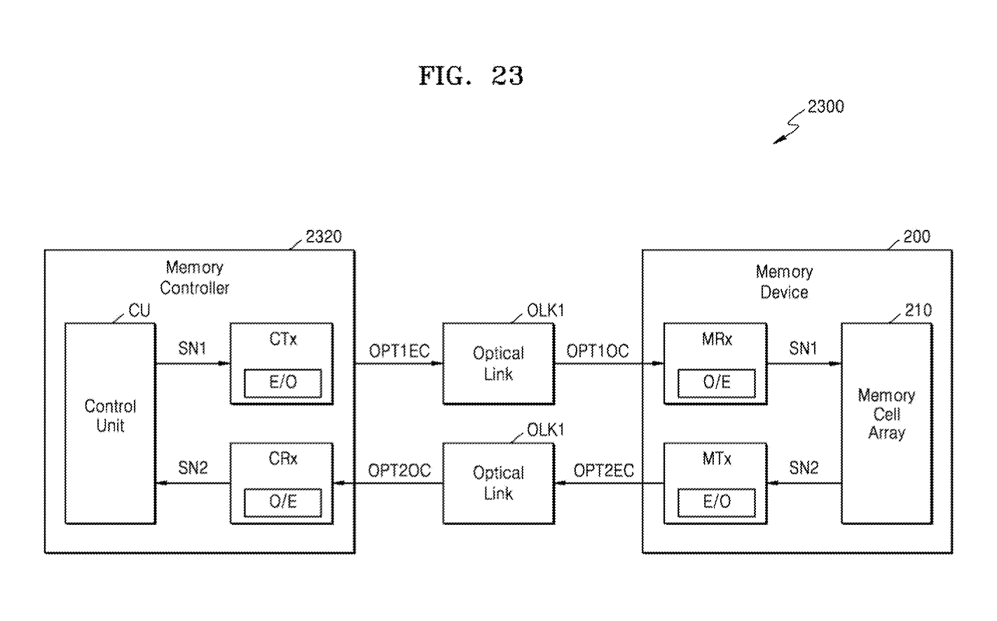

FIG. 22 is a block diagram of a memory system 2200 according to another embodiment of the inventive concept. Referring to FIG. 22, the memory system 2200 includes a memory controller 2220 and a memory device 200. The memory device 200 may have the same structure as the memory device 200 of FIG. 2 and may perform operations of FIG. 1 to improve reliability of the memory system 2200. In the memory system 2200 of FIG. 22, the memory device 200 may be a low-power double data rate (LPDDR) DRAM that uses a wide I/O interface, and the memory controller 2220 may include a wide I/O controller to communicate with the memory device 200 through the wide I/O interface. The wide I/O interface of the memory system 2200 of FIG. 22 may be driven at a power of 1.2V, operate with 4 channels and 128 bits, and be driven at a transmission rate of 2133 Mtps.

FIG. 23 is a block diagram of a memory system 2300 according to an embodiment of the inventive concept. The memory system 2300 of FIG. 23 includes optical link devices OLK1 and OLK2, a memory controller 2320, and a memory device 200. The memory device 200 may be a DRAM chip. The optical link devices OLK1 and OLK2 interconnect the memory controller 2320 and the memory device 200. The memory controller 2320 includes a control unit CU, a first transmitter CTx, and a first receiver CRx. The control unit CU transmits a first electric signal SN1 to the first transmitter CTx. The first electric signal SN1 may include a CS signal, a clock signal, data, etc. that are transmitted to the memory device 200.

The first transmitter CTx includes an optical modulator E/O that converts the first electric signal SN 1 into a first optical transmission signal OTP 1 EC and transmits the first optical transmission signal OTP1 EC to the optical link device OLK1. The first optical transmission signal OTP1 EC is transmitted as serial communication through the optical link device OLK2. The first receiver CRx includes an optical demodulator O/E that converts a second optical reception signal OPT2OC received from the optical link device OLK2 into a second electric signal SN2 and transmits the second electric signal SN2 to the control unit CU. The memory device 200 includes a second receiver MRx, a memory cell array 210, and a second transmitter MTx. The second receiver MRx includes an optical demodulator O/E that converts a first optical reception signal OPT1OC received from the optical link device OLK1 into a first electric signal SN1 and transmits the first electric signal SN1 to the memory cell array 210.

The memory cell array 210 writes write data in a memory cell in response to the first electric signal SN1 or transmits read data as a second electric signal SN2 to the second transmitter MTx. The second electric signal SN2 may include a clock signal, read data, etc. that are transmitted to the memory controller 2320. The second transmitter MTx includes an optical modulator E/O that converts the second electric signal SN2 into a second optical transmission signal OPT2EC and transmits the second optical transmission signal OPT2EC to the optical link device OLK2. The second optical transmission signal OTP2EC is transmitted as serial communication through the optical link device OLK2. The memory device 200 according to a present embodiment may have the same structure as the memory device 200 of FIG. 2 and may perform the operations of FIG. 1. For example, the memory device 200 of FIG. 23 may replace an address of a region in which a large number of errors occur with another address, for example, that of a redundancy memory cell array, to lower the probability that an error will occur, when the error occurrence probability exceeds an error correction capability of an on-chip ECC, thereby improving reliability.

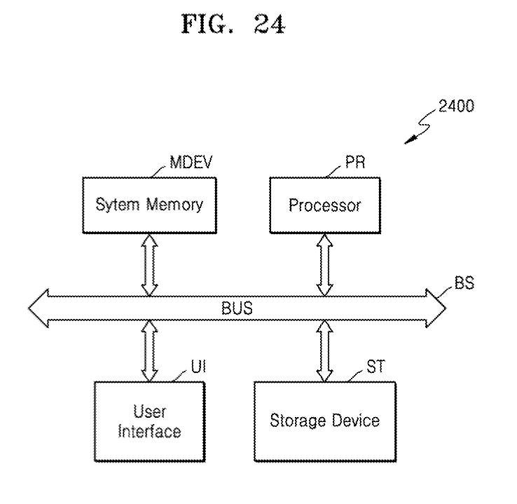

FIG. 24 is a block diagram of a computing system 2400 that includes a memory system according to an embodiment of the inventive concept. Referring to FIG. 24, a memory device may be installed as a system memory MDEV in the computing system 2400, which may be a mobile device, a desktop computer, etc. The memory device installed as the system memory MDEV may be implemented by one of a plurality of embodiments described above. For example, the system memory MDEV may be the memory device 200 according to an embodiment of the inventive concept which can replace an address of a region in which a large number of errors occur with another address, for example, that of a redundancy memory cell array, to lower the probability that an error will occur, when the error occurrence probability exceeds an error correction capability of an on-chip ECC of the memory device 200, thereby improving reliability. In addition, the system memory MDEV of FIG. 24 may include a memory device and a memory controller. The computing system 2400 according to a present embodiment includes a processor PR, the system memory MDEV, a user interface UI, and a storage device ST, which may include a nonvolatile memory, that are electrically connected to one another through a bus BS. The storage device ST may be a large capacity storage device such as a solid state drive (SSD) or a hard disc drive (HDD).

According to a memory device and a method of operating the memory device according to an embodiment of the inventive concept, a memory chip may include on-chip ECC to improve error correction efficiency. In addition, if a probability that an error will occur in an arbitrary unit, such as a row unit, increases, a corresponding address may be statically replaced with an address of a redundancy cell array to perform a reliable ECC operation under a restricted error correction capability of the on-chip ECC. For example, in a memory device that includes on-chip ECC with a 1-bit error correction ability with respect to an error correction unit based on restrictions on chip area, operation latency, power consumption, etc., the number of correctable errors that occur in an arbitrary unit, such as a row unit, may be counted. If the number of correctable errors that occurs in each row is greater than or equal to a preset value, a corresponding row may be replaced with another row to lower an occurrence probability of an uncorrectable error of 2 bits in an error correction unit. In other words, although a correctable error may be detected by the on-chip ECC, if the number of errors is greater than or equal to a predetermined value, it may be determined that a probability that a correctable error will occur in a corresponding area is high. Therefore, access to a corresponding area may be restricted to lower an occurrence probability of an uncorrectable error through the on-chip ECC.

Therefore, reliability of a memory device or a system that includes the memory device may be improved. Here, an address that replaces an address of a region in which there is a high probability that a correctable error will occur may be that of a redundancy cell array, which may minimize an increase in the chip area.

While embodiments of the inventive concept has been particularly shown and described with reference to exemplary embodiments thereof, it will be understood that various changes in form and details may be made therein without departing from the spirit and scope of the following claims.

What is claimed is:

1. A method of operating a memory device comprising an on-chip error check and correction (ECC), the method comprising:
checking for errors in data read from a first address of a memory cell array of the memory device;
counting the number of errors that occurred in data read from the first address;
receiving a first command for data read from the first address;
determining whether the number of errors that occurred in data read from the first address is greater than or equal to a first value; and
mapping the first address to a second address, if the number of errors that occurred in data read from the first address is greater than or equal to the first value.

2. The method of claim 1, wherein checking for errors in the data read from the first address is performed in response to a read command or a refresh command.

3. The method of claim 1, wherein the first command is a refresh command.

4. The method of claim 1, wherein the first address refers to a normal cell array of the memory cell array, and the second address refers to a redundancy cell array of the memory cell array.

5. The method of claim 1, wherein the first address is a row address of the memory cell array.

6. The method of claim 1, further comprising, if the number of bit errors in each error correction unit of the data read from the first address is less than or equal to a maximum number of bit errors that are corrected by the on-chip ECC, storing the number of errors that occurred in data read from the first address in a first table.

7. The method of claim 1, further comprising:
storing mapping information of the first and second addresses in a second table, if the number of errors occurring in data read from the first address is greater than or equal to the first value.

8. The method of claim 7, further comprising:
receiving a second command for data read from the first address; and
executing the second command with respect to data at the second address with reference to the second table.

9. The method of claim 7, further comprising:
checking for errors in an error correction unit of the data read from a whole region of the first address; and
deleting information about the first address from the second table, if the number of errors that occurred in the data read from the whole first address is less than or equal to a second value.

10. The method of claim 9, further comprising:
storing in a third table the number of errors that occurred in the data read from the first address, if an error occurs in an arbitrary error correction unit of the data read from the first address.

11. The method of claim 1, further comprising storing the number of errors in a first table,
wherein determining whether the number of errors that occurred in data read from the first address is greater than or equal to the first value comprises:
referring to the first table, if the first command is received; and
referring to a first flag of the first table to determine whether the number of errors that occurred in data read from the first address is greater than or equal to the first value, if the first address exists in the first table.

12. The method of claim 1, wherein the first address refers to a first redundancy cell array of the memory cell array, and the second address refers to a second redundancy cell array of the memory cell array.

13. The method of claim 1, wherein the memory device is a dynamic random access memory (DRAM).

14. A method of operating a memory device comprising an on-chip error check and correction (ECC), the method comprising:
reading data from a first address of a memory cell array of the memory device and checking whether a correctable error occurs in the read data, when performing a read or refresh operation with respect to the first address;
counting the number of errors that occurred in the data read from the first address and, if the number of errors is greater than a predetermined value, determining that the first address is an address in which there is a high probability that an uncorrectable error will occur;
writing data stored at the first address to a second address; and
if an access to the first address is requested, changing the access to the first address into an access to the second address.

15. The method of claim 14, wherein the first address refers to a normal cell array of the memory cell array, and the second address refers to a redundancy cell array of the memory cell array.

16. A method of operating a memory device comprising an on-chip error check and correction (ECC), the method comprising:
receiving an active command for data at a first row address;
determining whether the first row address exists in a second table, wherein a wordline of a second row address mapped to the first address is activated, if the first row address exists in the second table, and a wordline of the first row address is activated, if the first row address does not exist in the second table;
receiving a column address of a read command; and
performing error check and correction on data at the column address.

17. The method of claim 16, further comprising:
increasing a number of errors that may occur in data at the first row address, if the error check and correction detected a correctable error and the first row address exists in a first table;
storing the first row address in the first table, if the error check and correction detected a correctable error and the first row address does not exist in a first table, wherein if an empty entry for storing the first row address does not exist in the first table, a least recently entry is deleted from the first table; and
outputting data read from the column address.

18. The method of claim 17, further comprising:
receiving a refresh command for data at the first row address;
if the first row address exists in the second table and a second flag is set to zero,
activating a wordline of the first row address;
detecting and correcting errors in data read from the activated first row address, wherein if a correctable error occurred in data read from the activated first row address, a number of errors that occurred in data read from the activated first row address is increased; and
determining whether the number of errors that occurred in data read from the activated first row address is less than or equal to a second value, wherein if the number of errors is less than or equal to the second value, a second flag is set to one and a wordline of a second row address is inactivated, and if the number of errors is greater than the second value, the wordline of the second row address is activated.

19. The method of claim 18, wherein, if the first row address does not exist in the second table, the method comprises:
performing the refresh operation on data of the first row address, if the first row address does not exist in a first table, or the first flag of a first row address is not set to one.

20. The method of claim 18, wherein if the first row address does not exist in a second table, the method comprises:
searching for a second row address to replace the first row address, if the first row address exists in the first table and the first flag of a first row address is set to one;
wherein if the second row address is found, mapping information of the first row address and the second row address is stored in a second table, moving data stored at the first row address to the second row address, and deleting an entry of the first row address from the first row table; and
wherein if the second row address is not found, performing the refresh operation on data of the first row address.
